(19) United States
(12) Patent Application Publication
(10) Pub. No.: US 2005/0263233 A1
(43) Pub. Date: Dec. 1, 2005

(54) Two material over-molded fitment

(76) Inventors: Terrence P. Meier, Naperville, IL (US); James S. Zielinski, Schaumburg, IL (US); Jeffrey M. Stupar, West Dundee, IL (US); Deepak Mehta, Naperville, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/123,366

(22) Filed: May 6, 2005

Related U.S. Application Data
(62) Division of application No. 10/619,956, filed on Jul. 15, 2003.
(60) Provisional application No. 60/408,148, filed on Sep. 4, 2002.
(60) Provisional application No. 60/429,698, filed on Nov. 27, 2002.

(51) Int. Cl. B32B 31/00

(52) U.S. Cl. 156/60; 264/250

(57) ABSTRACT

An over-molded fitment is configured for mounting to a flexible packaging material. The fitment includes a flange having first and second sides, a spout extending upwardly from the first side of the flange and an over-molded sealing media molded onto the first side of the flange. The flange and spout are integral with one another and formed from a single first material. The over-molded sealing media is formed from a second material different from the first material and having a density less than a density of the first material. The sealing media permits joining the different materials of the flexible packaging and the fitment that would otherwise not seal to one another. A method for forming the over-molded fitment and a package formed with the fitment are also disclosed.

### CROSS REFERENCE TO RELATED APPLICATION DATA

This application claims the benefit of priority of provisional U.S. Patent application Ser. No. 60/408,148, filed Sep. 4, 2002 and provisional U.S. Patent application Ser. No. 60/429,698, filed Nov. 27, 2002.

### BACKGROUND OF THE INVENTION

The present invention is directed to a molded fitment. More particularly, the present invention is directed to a fitment that is affixed to packaging material for dispensing product from the packaging material, which fitment is over-molded to enhance affixing the fitment to the packaging material.

The packaging industry, generally, has seen advances in both the packaging medium, as well as in devices that facilitate dispensing and provide enhanced resealability of a package. As to the packaging materials, the trend has, for some types of product shifted from “hard” packages to more flexible materials. For example, many products that previously were packaged in metal, glass or other rigid containers, there has been a shift toward the use of flexible packaging. The flexible materials provide a number of advantages insofar as handling and shipping.

As an example, in order to package a product in a glass container, the container must first be fabricated then packaged and shipped to a facility for the product to be packaged or filled in to the container. The container is then repackaged and shipped for end use distribution. The containers, and in particular glass and many other rigid containers, must be carefully packaged to avoid breakage.

One shift has been to the use of flexible plastic package materials. It has been found that flexible packaging can be used for solid, liquid and “mixed” product, with success. Materials such as low density polyethylene (LDPE) have been found to be acceptable for a wide variety of product types, such as food and household products (e.g., liquid cleaners). It is, however, also desirable to be able to reseal the packages after initial use.

Another shift has been to the use of polymer (plastic) spouts or fitments to provide access to the product in the package. These fitments permit ready access to the product while also providing resealability of the container to prevent contamination of the product (e.g., oxygen ingress and subsequent oxidation of the product), as well as leakage or spillage of product from the package. Typical fitments include a flange and a rigid upstanding tubular spout having a thread thereon or a bayonet-type connection for receiving a mating closure cap. The fitments are formed from a rigid material so that the fitment retains its shape for receiving the closure and maintaining the closure engaged with the fitment for resealing. Typically, the fitments are mounted to the container at the flange.

Various successful methods have been developed for affixing or mounting spouts to rigid containers such as paperboard cartons. These include ultrasonic sealing, heat sealing, adhesives (such as hot-melt glue) and the like. These heat activated methods have been found to be better than the non-heat activated methods in that the seal between the spout and the container forms and sets or hardens faster than with traditional adhesives. In the heat activated methods, a plastic coating on the container “melts” into the fitment flange, thus fusing the plastic coating and the flange.

One problem that has been encountered with the use of such fitments with flexible packaging is that the disparity between “softening” point temperatures (of the flange material and the packaging material) is such that the packaging material will melt prior to establishing a proper seal between the fitment flange and the packaging material. As such, the integrity of the package itself may be compromised. In addition, in that these processes are typically carried out at high throughputs (i.e., high volume processing), the amount of time necessary to carry out the mounting, both the heating and cooling times, is critical in order to maintain the overall process line speed.

Accordingly, there exists a need for a fitment formed from a material that is compatible with flexible packaging that can be affixed to the packaging using known, heat activated methods. Desirably, such a fitment is usable with packaging materials that are known to be acceptable for use with food products. Most desirably, such a fitment is usable with known, standard devices for sealing the fitment to the packaging material.

### BRIEF SUMMARY OF THE INVENTION

An over-molded fitment is configured for mounting to flexible packaging. The fitment includes a flange having first and second sides, a spout extending upwardly from the first side of the flange and an over-molded sealing media molded onto the first side of the flange. The flange and spout are integral with one another and formed from a single first material. The over-molded sealing media is formed from a second material different from the first material. The sealing media permits joining the different materials of the flexible packaging and the fitment that would otherwise not seal to one another.

Such a fitment is usable with packaging materials that are known to be acceptable for use with food products and is usable with known, standard devices for sealing the fitment to the packaging material. Advantageously, the fitment can be formed from a material that, unlike known fitment materials, is highly oxygen imperious.

A method for forming an over-molded fitment and a package formed using the fitment are also disclosed

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 illustrates an over-molded fitment embodying the principles of the present invention, the fitment being shown with a cooperating closure or cap separated therefrom for ease of illustration; and

FIG. 2 illustrated the over-molded fitment sealed to a portion of packaging material and having the closure engaged with the fitment.

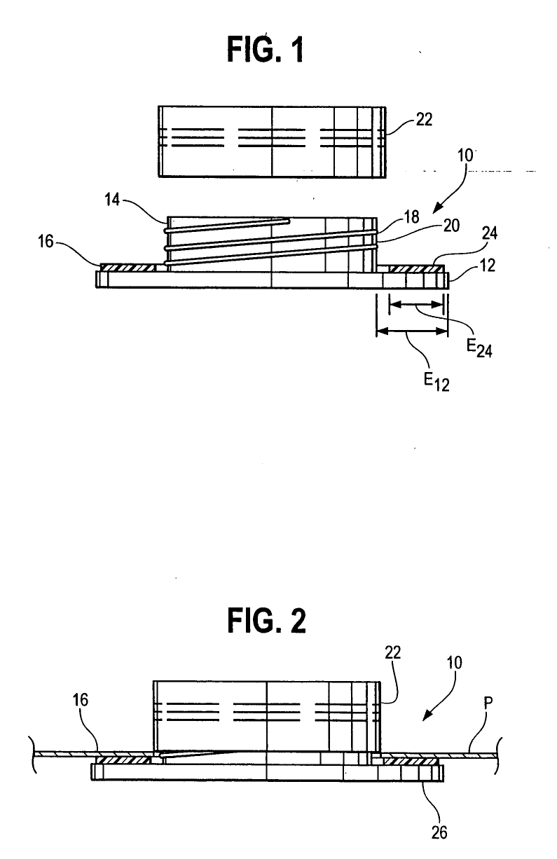

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

Referring now to the figures there is shown an over-molded fitment 10 embodying the principles of the present invention. The fitment 10 is formed or configured for mounting to packaging P and in particular for mounting to flexible packaging. Those skilled in the art will recognize that the flexible packaging P can be formed from various materials, of which low density polyethylene (LDPE) or multi-laminate structures with an LDPE sealant layer (such as polyester/LDPE, nylon/LDPE and the like) is exemplary. LDPE is a widely used material that it is readily commercially available, is generally reasonably economically viable, and has been approved for use in the packaging of food products. Other flexible packaging P materials will be recognized by those skilled in the art and are within the scope and spirit of the present invention.

The illustrated fitment 10 includes a flange 12 for mounting to the packaging P, and an upstanding spout 14 extending (upwardly) from a first side 16 of the flange 12. The illustrated fitment 10 includes a thread 18 formed on an outer surface 20 of the spout 14 for engaging a closure or cap 22 having a mating thread formed on an inner surface thereof (not shown). Those skilled in the art will recognize and appreciate that the fitment 10 can be formed with any of a number of other types of mounting arrangements, such as bayonet-type mounts, snap-cap mounts and the like which other types of mounting arrangements are within the scope and spirit of the present invention. In a typical mounting, the fitment 10 is mounted to the package P at the flange first side 16, or that side of the flange 12 from which the spout 14 extends.

In that the fitment 10 is configured to retain its rigidity and shape during use and during, for example, sterilization processes, it has been found that one acceptable material is high density polyethylene (HDPE). HDPE has a sufficiently high softening point or temperature so that the fitment 10 will retain its rigidity and shape when subjected to temperatures typically used in steam sterilization processes in the food packaging industry. HDPE has a melting point temperature of about 266° F. (130° C.).

Problems have, however, been encountered in mounting these fitments 10 to LDPE and other packaging films. It has been found that cycle times of about 8 seconds to about 9 seconds at temperatures of about 265° F. are required in order to effect an acceptable seal between the LDPE film and the HDPE fitment. Even under these process conditions, the seal between the materials may not be sufficiently strong, and of sufficient integrity to meet the packaging criteria and standards (for example, the standards under which sterilization is carried out). Moreover, because the mounting operation is typically carried out in a high speed operation, this relatively long cycle time (8-9 seconds) is unacceptable.

The fitment 10 includes a layer of material 24 that is over-molded on the face or side 16 of the flange 12 that is configured for sealing to the packaging P material (defining a sealing region 26). The over-mold 24 material is a low melt polymer formulated to provide a faster cycle time for sealing to the LDPE packaging P material. The low melt polymer serves as a tie layer between the HDPE fitment 10 material and the LDPE packaging P material.

In a present fitment 10, the low melt tie layer 24 is molded over or onto the flange face 16. That is, subsequent to the injection molding process for forming the fitment 10, the low melt material 24 molded onto the fitment 10, over the flange face 16. It has, however, been observed that the adhesion between the low melt tie layer 24 and the HDPE fitment face 16 can be less than acceptable. It is believed that many low melt tie layer materials do not process at sufficiently high temperatures (e.g., have too low of a melting point temperature) to melt the HDPE material and thus properly fuse the materials to one another. It was found that although better adhesion was achieved if the melting point temperature of the HDPE (about 266° F.) was exceeded, this also resulted in the HDPE insert (i.e., the HDPE fitment 10 serving as a substrate) being penetrated and the over-mold or tie layer 24 material flowing to and into areas of the fitment 10 that are undesirable. Thus, an upper melt temperature processing limitation was identified, above which temperature the integrity of the fitment 10 was possibly compromised.

Attempts were made to over-mold onto the HDPE material using an LDPE material tie layer and using an ethylene vinyl acetate (EVA) material tie layer. With respect to the LDPE tie layer, it was found that sufficient adhesion was not achievable between the LDPE and the HDPE material (as a substrate). In those attempts using the EVA material, likewise, sufficient adhesion was not achieved, even with vinyl acetate concentrations at about 28 percent of the EVA composition.

Sample HDPE fitments 10 were then prepared using an over-mold 24 of a polyolefin plastomer. The plastomer used was a homogeneously branched ethylene-octene copolymer composition. The plastomer has a relatively low density, lower than the HDPE. In the present embodiment, the homogeneously branched ethylene-octene copolymer has a density of less than 0.90 grams per cubic centimeter (g/cc) and preferably a density of about 0.875 g/cc. Such a plastomer is commercially available from The Dow Chemical Company, Dow Plastics business group of Midland, Mich. under the trade name Affinity KC 8852. It is believed that the plastomer is a linear low density polyethylene (LLDPE).

It was found that the polyolefin plastomer (which has a relatively low melting point temperature of about 155° F.) provided excellent adhesion to the HDPE fitment 10 material and further resulted in a surprisingly strong heat seal between the fitment 10 and the packaging P material, at relatively low heat seal cycle times (about 2.5 seconds as compared to about 8-9 seconds for currently known materials). Using a sealing head temperature of about 230° F. and a cycle time of about 2.5 seconds or less, a film tearing heat seal was achieved. In other words, in attempting to separate the fitment 10 from the packaging P material the packaging P material or film tore, rather than the region at which the seal 26 was made between the fitment 10 and packaging P material. It is believed that this was due to substantially complete fusion between the plastomer and the HDPE. That is, the adhesion between the plastomer and the HDPE substrate was about as strong as the material, providing a strong, rapidly effected heat seal.

Another low melt tie material 24 was also found to perform well in establishing a good seal between the HDPE fitment 10 material and the LDPE packaging P material, while at the same time forming a good bond (e.g., successful fusion) between the tie material and the fitment 10. In particular, ethylene acrylic acid (EAA) copolymers were found to bond well to the HDPE material and to form a good seal between the HDPE fitment 10 and the LDPE packaging P material; however, not as good a seal as the homogeneously branched ethylene-octene copolymer. Two specific EAA copolymers used were Primacor 3340 and Primacor 3460 also commercially available from the Dow Plastics business group of Midland, Mich.

In evaluating acceptable over-mold 24 materials, it was found that LDPE did not form a good bond (e.g., no material fusion) with the HDPE fitment 10 material; the EVA materials formed a weak bond with the HDPE (in fact, almost no bond was realized); and the polyolefin plastomer (LLDPE) material formed a surprisingly good and strong bond (e.g., substantially complete fusion) with the HDPE material.

In sample fitments 10 prepared in accordance with the present invention, a fitment 10 having a flange 12 with a radial extension E₁₂ of about 3/8 inch had an over-mold portion 24 molded thereon having a radial extension E₂₄ of about 1/4 inch and a thickness of about 1/16 inch.

In carrying out the present over-mold, a fitment 10 was formed using, for example, standard, known injection molding techniques. The fitment 10 was then positioned in a subsequent mold (not shown) that included a cavity into which the fitment was positioned and having a cut-out or additional mold cavity conforming to the shape and size of the over-mold portion (i.e., an over-mold cavity). The over-mold 24 material was then injected into the over-mold cavity onto the fitment flange 16.

The over-molding process was carried out at a temperature of about 455° F. (235° C.), which is about 300° F. (167° C.) above the melting point temperature of the polyolefin plastomer (melt point temperature of about 155° F. (68° C.)). The HDPE fitment material used has a melting point temperature of about 266° F. (130° C.) and the LDPE packaging material has a melting point temperature of about 195° F. to 230° F. (about 90° C. to 110° C.). The sealing process, that is the process in which the fitment 10 with the over-mold 24 is sealed to the LDPE packaging P material was carried out at a sealing head temperature of about 230° F. (110° C.).

It is anticipated that the present over-molded fitment 10 will function well with other packaging P materials, such as EVA, polyester laminates and like flexible materials. Those skilled in the art will recognize the various other materials that can be used to form the over-mold portion, which will have the necessary bonding characteristics to the fitment and packaging materials, which other over-mold materials are within the scope and spirit of the present invention.

Those skilled in the art will recognize that although HDPE is widely used as a material for the fitment 10, it nevertheless does not have good oxygen barrier properties. That is, while the LDPE package P material provides excellent oxygen barrier characteristics, the HDPE spout or fitment 10 could be construed as the “weak link” in preventing oxygen introduction to the package.

To this end, it has also been found that other materials provide better oxygen barrier characteristics than the widely used HDPE. For example, ethylene vinyl alcohol copolymer (EVOH) has been found to have oxygen barrier characteristics that exceed those of HDPE. However, it has also been observed that EVOH does not seal (e.g., heat seal or weld) well to the underlying LDPE package P material. Thus, although the materials in and of themselves provide excellent oxygen barrier characteristics, they are incompatible vis-a-vis forming a seal when joined together.

To provide a structure having the ability to form a seal between these materials, an overmold 24 is formed on the flange 12 of the fitment 10. The overmold 24 includes a plastomer such as the above-noted homogeneously branched ethylene-octene copolymer (e.g., the Dow Chemical Company Affinity KC 8852), in combination with a modifier to provide good adhesion between the overmold material and the fitment (EVOH) and to provide a good seal between the overmold 24 material and the LDPE package P material. A present modifier is a maleated polyolefin material, such as a polyalphaolefin copolymer, commercially available from the Mitsui Chemicals America, Inc. of Purchase, N.Y. under the product name Tafiner MH 7020. In a present overmold 24 material, the branched ethylene-octene copolymer is present in a concentration of about 75 percent by weight and the maleated polyolefin is present in a concentration of about 25 percent by weight.

It has been found that this combination of EVOH fitment 10 and branched ethylene-octene copolymer/maleated polyolefin (in a 75/25 weight percent combination) overmold 24 material provides an exceptionally and surprisingly good seal when the overmold 24 material is applied to (i.e., molded to) the fitment flange 12 at a mold temperature of about 550° F.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1-9. (canceled)

10. A method for forming an over-molded fitment comprising the steps of
forming a fitment from a molded material;
positioning the formed fitment in a mold;
molding an over-molded sealing region onto a portion of the fitment; and
fusing the over-molded sealing region to the fitment.

11. The method for forming an over-molded fitment in accordance with claim 10 including the step of molding the over-molded sealing region onto the fitment at a temperature less than a melting point temperature of a material from which the fitment is formed.

12. The method for forming an over-molded fitment in accordance with claim 10 including the step of forming the fitment from a high density polyethylene material.

13. The method for forming an over-molded fitment in accordance with claim 10 including the step of forming the over-molded sealing region from a homogeneously branched ethylene-octene copolymer material.

14. The method for forming an over-molded fitment in accordance with claim 10 including the step of forming the fitment from an ethylene vinyl alcohol copolymer and forming the overmolded sealing region from a composition including an ethylene-octene copolymer.

15. The method for forming an over-molded fitment in accordance with claim 14 wherein the wherein the overmolded sealing region composition further include a maleated polyolefin.

16. The method for forming an over-molded fitment in accordance with claim 15 wherein the overmolded sealing region composition includes the ethylene-octene copolymer in a concentration of about 75 percent by weight of the overmolded sealing region material and includes the maleated polyolefin in a concentration of about 25 percent by weight of the overmolded sealing region material.

17. The method for forming an over-molded fitment in accordance with claim 14 wherein the overmolded sealing region is molded onto the portion of the fitment at a temperature of about 550° F.

18-27. (canceled)

28. The method for forming an over-molded fitment in accordance with claim 10 further comprising the steps of
positioning the over-molded sealing region against a flexible packaging material; and
activating the over-molded sealing region with heat so as to effectively weld the fitment to the flexible packaging material.
